(19) United States
(12) Patent Application Publication
(10) Pub. No.: US 2009/0301191 A1
(43) Pub. Date: Dec. 10, 2009

(54) DEVICE FOR DETECTING AT LEAST ONE CHEMICAL CONSTITUENT

(75) Inventors: Stefan Dick, Weichering (DE); Mandy Erdmann, Landshut (DE); Inge Kramer, Riehen (CH); Michael Haubs, Bad Kreuznach (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: SUD-CHEMIE AG, Munchen (DE)

(21) Appl. No.: 11/722,427

(22) PCT Filed: Dec. 21, 2005
(86) PCT No.: PCT/EP05/13791

§ 371 Date: May 11, 2009

(30) Foreign Application Priority Data
Dec. 22, 2004 (DE) 102004061927.1

(51) Int. Cl. G01N 21/81; B65D 83/04

(52) U.S. Cl. 73/335.01; 206/531

(57) ABSTRACT

The invention relates to a device for detecting at least one chemical component, the device comprising a light-reflecting substrate or light-reflecting background and a superior detecting layer containing at least one component swellable in the presence of the component to be detected, the detecting layer consisting of a homogeneous material and the component to be detected comprising water.

This invention relates to a device for detecting at least one chemical component, in particular water or water vapor, wherein a detecting layer utilizes a component that swells in the presence of the chemical component to be detected.

Some prior art humidity indicators are based on cobalt (II) compounds (or other inorganic salts). A change in humidity will result for example in a color change of the cobalt (II) compound and can be read off. However, cobalt is a heavy metal and so has become controversial, and the demand for cobalt-free humidity indicators has correspondingly risen.

Humidity can generally be determined using capacitative, resistive, hygrometric, gravimetric or optical techniques.

Capacitative sensors are based on dielectric change of thin layers on taking up water vapor. The properties of these sensors are determined by the hygroscopic material and by their electrode geometry. A layered arrangement has proved satisfactory in the capacitative determination of water vapor content. The layered arrangement comprises, on a substrate surface, a sequence of superposed layers consisting of a base electrode, a water vapor sensitive layer and a covering electrode.

Resistive humidity sensors are instruments that indicate relative humidity in impedance changes. This can be measured using current, voltage or resistance. Ceramic materials are particularly useful since they have very good properties with regard to mechanical integrity, reproducibility, service life, ease of handling and resistance to environmental influences. Disadvantages of ceramic humidity sensors are hysteresis phenomena and atmospheric phenomena at high humidity concentrations in particular.

An electrolytic humidity sensor is essentially a humidity measuring instrument based on lithium chloride sensors. Two properties of LiCl are exploited. First, LiCl is hygroscopic, i.e., it adsorbs water molecules; secondly, the resulting salt solution is an electrolyte which conducts electric current. An immense disadvantage of electrolyte humidity sensors based on LiCl is their relatively slow response time. Nor should they be used in very humid surroundings, since this leads to adverse influences in the precision and service life of the sensor. Of particular disadvantage here are the aging effects of the sensor due to crystal formation on the part of the LiCl.

The quartz crystal microbalance (QCM) is the best known gravimetric humidity sensor. Thin plates of piezoelectric quartz have resonance frequencies (thickness and/or shearing mode) in the MHz region. Coated with a hygroscopic layer, a change in frequencies is used to measure the humidity. When using an uncoated reference resonator, the cross sensitivity of pressure and temperature can be minimized.

The physical background to the optical humidity sensor is a harmonic electromagnetic wave of amplitude E₀, frequency ω and phase Φ:

E(t)=E₀ cos(ωt−Φ).

Information about relative humidity can be obtained through the amplitude, the polarization, the frequency or the phase of the wave. Another possible use utilizes the absorption wavelength of water: when light passes through gas the absorption of certain wavelengths gives a clue as to composition.

Humidity measurements by means of color hygrometers rely on color changes by salts containing water of crystallization. Color hygrometers consist of a series of different pulp platelets provided with scale divisions and saturated with the salts of, for example, cobalt (II) compounds, copper sulfate, copper chloride or nickel chloride. The use of heavy metal salts is a decisive disadvantage of these color hygrometers.

Kleinfeld and Ferguson (Chem. Mater. 1995, 7, page 2327; Science, Vol. 265 (1994), page 370) describe the formation and use of multilayered nanostructural films from macromolecular precursor compounds. Poly(diallyldimethylammonium chloride) (PDDA) and hectorite are processed into multilayered films on silicon substrates. These multilayered films are capable of reversibly sorbing water, which is why use as a molecular sensor is discussed.

However, there is a huge demand for alternative and improved indicator systems for chemical components, in particular for water or water vapor (humidity, moisture) in an environment to be monitored, which are not only simple to manufacture but also permit advantageous detection of the chemical component, in particular water or water vapor, to be detected.

This object is achieved according to a first aspect of the invention by the device according to claim 1.

The present invention accordingly provides in one aspect initially a device for detecting at least one chemical component, the device comprising a light-reflecting substrate or light-reflecting background and a superior detecting layer containing at least one component swellable in the presence of the component to be detected, the chemical component to be detected coming into contact with the detecting layer and the detecting layer being capable through interaction with the chemical components to be detected of changing its layer thickness, as a result of which the color of the detecting layer changes in reflected light. The chemical component to be detected comprises very preferably water or water vapor. It was found that the devices described herein are particularly useful for detecting water or water vapor. “Water or water vapor” shall comprise not only liquid water or water in liquid media but also in particular water in the gaseous state or in gaseous media such as air.

It has now been found that, surprisingly, particularly simple and advantageous detecting layers are obtainable when the detecting layer on the one hand contains at least one component capable of swelling in the presence of the chemical component to be detected, but on the other hand does not, as described by Kleinfeld and Ferguson (loc. cit.), consist of an inhomogeneous material. This result was all the more surprising as the above-cited Kleinfeld and Ferguson reference describes the synthetic exfoliated hectorite arranged in layers or plies as being an essential element of the swellable detecting layer. Yet it was unexpectedly found in the realm of the present invention that the use of a homogeneous material as a detecting layer has a positive influence not only on the response times, i.e., the delay until there is a detectable color change, but also the color intensity and/or the secondary swell time of the detecting layer. A homogeneous material is thus particularly preferred for use as detecting layer.

A homogeneous material for the purposes of the present invention is a material which either contains only one component or, if it contains two or more components, these components are evenly (homogeneously) distributed or mixed in the layer. This shall ensure that the refractive index of the detecting layer is the same throughout the entire thickness of the layer. A homogeneous distribution can be ensured in a conventional manner, for example by intensively mixing the components before the detecting layer is formed. A multilayered construction of the detecting layer from plies of differing refractive index and differing composition as in Kleinfeld and Ferguson (loc. cit.) is thus consciously avoided. It was found that this can have a positive influence not only on the response times, the color intensity but also the secondary swell time of the detecting layer.

In a preferred embodiment according to the present invention, the detecting layer further does not contain any platelet-shaped sheet-silicates. It is believed, without the invention being restricted to the correctness of this belief, that the presence of platelet-shaped substances such as synthetic hectorite lengthens the diffusion paths in or within the detecting layer for the substance to be detected. Platelet-shaped sheet-silicates as such are familiar to one skilled in the art and need not be more particularly elucidated here. In other words, it is believed that the platelet-shaped sheet-silicate particles constitute (diffusion) barriers for the substance to be detected, so that homogeneous swelling on the part of the detecting layer on taking up the component to be detected is inhibited or delayed. This can lengthen not only the response time for the detecting layer until the attainment of a detectable color change but also the time delay until a defined ultimate degree of swelling is achieved under certain conditions. Accordingly, the time lengthens until an ultimate change in color, which is no longer changed by a secondary swelling of the layer, can be read off. It is also possible in this connection for a subsequent redistribution of the chemical component to be detected and taken up in the detecting layer to take place between the platelet-shaped sheet-silicate (synthetic hectorite) and the polyelectrolyte (PDDA) and bring about a subsequent change in the layer's thickness under unchanged environmental conditions. Since such a subsequent change in layer thickness again hinders or delays the reading off of a defined color change at a certain concentration of the chemical component to be detected in the environment, this is disadvantageous. In a preferred embodiment, the detecting layer or the layers arranged on the light-reflecting substrate therefore do not contain any platelet-shaped sheet-silicates such as hectorite or the like.

In contrast, the present invention's detecting layers or devices without synthetic hectorite (without platelet-shaped sheet-silicates) permit a rapid and homogeneous takeup in the detecting layer of the chemical component to be detected. A surprising consequence is a particularly rapid response time to a change in the concentration in the environment of the chemical component to be detected and quite minimal secondary swelling, so that the ultimate change in color can be read off particularly quickly.

It has further been determined that, surprisingly, the color intensities attainable by means of the devices of the present invention are extraordinarily good. This is found particularly distinctly for example when the device of the present invention is used to determine the relative humidity at low moisture contents, for example in the range between about 5% and 15%. At such low relative humidities, the devices with synthetic hectorite which are known from Kleinfeld and Ferguson (loc. cit.) for example show a fairly milky cloudy coloration of low color intensity. It is believed, without the invention being restricted to the correctness of this belief, that the presence of the synthetic hectorite in a platelet shape creates additional and, moreover, irregularly distributed refractive surfaces in the detecting layer which lead to an increased proportion of scattered light and hence to a less intensive coloration in reflected light. Synthetic hectorite is familiar to one skilled in the art and need not be discussed here any further. A platelet-shaped sheet-silicate is herein also to be understood as meaning such a sheet-silicate in the exfoliated or delaminated state.

In a further preferred invention, the detecting layer generally contains no particulate components, since this gave the best results. It is evidently the case that particulate components, even where not platelet shaped, frequently have an adverse influence on the attainable response and secondary swell times and also the color intensities. Nor, in one embodiment of the present invention, does the detecting layer and/or the device as a whole contain a dye, particularly no bronzing dye.

According to the present invention, the detecting layer contains at least one component (the detecting component) which is swellable in the presence of the component to be detected, and the detecting layer is capable of changing its thickness through interaction with the chemical components to be detected, so that the color of the detecting layer changes in reflected light.

Substances useful as detecting components are therefore capable of taking up the chemical component to be detected and of changing their volume, i.e., of swelling, as a result. The takeup can be effected for example through adsorption, absorption or other physical or chemical mechanisms of takeup/incorporation.

The utility of a substance as a detecting substance within the meaning of the present invention is simple to determine routinely from a substance's takeup or swell capacity. It is determined by weighing 5 g of the in-test substance into a Petri dish. The samples are dried to constant weight at room temperature in a vacuum drying cabinet (100 mbar, diaphragm pump). To shorten the drying time, the drying temperature can be raised depending on the detecting component (for example to about 70° C. in the case of polyacrylic acid), provided this does not lead to destruction of the detecting component. The Petri dishes with the dried substance are then transferred into a conditioning cabinet at 25° C., 40% relative humidity or 40% saturation in the gas phase with the component to be detected and the weight increase (adsorption of the component to be detected) is determined (to a constant weight). The result is percentage takeup capacity in % by weight, based on the detecting component, for the component to be detected.

In one preferred embodiment of the present invention, the detecting layer accordingly contains at least one component that swells in the presence of the component to be detected and has a takeup capacity of 10% to 30% by weight, in particular 15% to 27% by weight and preferably 18% to 25% by weight, based on the amount used for the component to be detected (as determined above).

In a preferred aspect, the present invention provides particularly efficient detecting layers when the at least one component swellable in the presence of the chemical component to be detected comprises at least one salt of a polyacid or polymeric acid. A person skilled in the art is familiar with polyacid or polymeric acid. More particularly, “polyacid” or “polymeric acid” is herein to be understood as referring to any polymer comprising monomer units having at least one acid function, in particular at least one carboxylic acid group. Such polyacids or polymeric acids are particularly useful, in the form of their salts in particular, for high-sensitivity devices for detecting water or water vapor. The polymer preferably contains more than 10, particularly more than 50 and more preferably more than 100 monomer units. In accordance with the present invention, using the polyacids in the form of their salts makes the hydrophilicity of the detecting layer optimizable. It also provides for a particularly good swell capacity. The use of polyacids in the form of salts advantageously makes possible very thin detecting layers, which are very sensitive and respond rapidly even to low moisture contents of a gaseous medium. It is particularly preferred for the salts of polyacids to be alkali metal salts. Na⁺, K⁺ and/or Li⁺ are particularly preferred as alkali metal ions.

The present inventors also found that, surprisingly, at least one polyacrylic acid is particularly useful as polyacid or polymeric acid. The salts of polyacrylic acids, in particular the alkali metal salts, gave unexpectedly sensitive and fast-responding detecting devices.

In a particularly preferred embodiment, the molar ratio of alkali metal ions to polyacid (or polymeric acid) in the device or the present invention's detecting layer is between 50 and 6500, in particular between 150 and 6500 and more preferably between 300 and 6500.

In a further preferred aspect of the present invention, the at least one component swellable in the presence of the chemical component to be detected consists essentially or completely of at least one salt of at least one polyacid, preferably at least one polyacrylic acid, in particular at least one alkali metal salt of at least one polyacrylic acid. It is particularly preferable for the at least one component swellable in the presence of the chemical component to be detected, or the detecting layer itself, to consist of at least one salt of at least one polyacid, preferably at least one polyacrylic acid, to an extent of more than 50% by weight, preferably more than 75% by weight, more preferably more than 90% by weight, more preferably more than 95% by weight, more preferably more than 98% or even 99% by weight or more.

In a further preferred embodiment of the present invention, the at least one salt of a polyacrylic acid is a completely or partially neutralized polyacrylic acid. The degree of neutralization is easily determined by titration and the establishment of titration curves. Preference is given in particular to polyacrylic acids partially or completely neutralized with alkali metal hydroxides or alkali metal carbonates, preferably to an extent in the range from 5% to 70%, more preferably to an extent in the range from 10% to 60% and in particular to an extent in the range from 15% to 50%.

In relation to the pH, it is preferable that the polyacid (in particular polyacrylic acid) used or its salt have a pH between about 3 and 7 and in particular between about 5 and 7. The pH can be determined in a conventional manner from the polyacid salt solution used to form the detecting layer, for example as more particularly described hereinbelow for an aqueous solution, using a pH meter.

In one embodiment of the present invention, the following substances have been found to be particularly useful detecting components: salts of polyacids such as methacrylic acid, glutamic acid, polyacrylic acid, or salts of amine-containing polymers such as polyethyleneamine. But also substances such as waterglass, polyphosphates, proteins, copolymers such as block copolymers (for example PO-EO block polymers), graft copolymers (such as PO-G-PEO) and also random or alternating copolymers (by way of literature concerning copolymers which can be tested for their utility in the realm of the present invention by means of routine tests, reference can be made for example to: Houben-Weyl, Methoden der organischen Chemie, 4th edition, editor: Eugen Müller, chapter 1); sulfonated polystyrene, polyvinylcaprolactam or cellulose acetate have been found to be useful. It has been determined to be particularly advantageous for the detecting layer to consist essentially or completely of the detecting component. Mixtures of two or more detecting components are also possible.

As observed above, the present inventors have also found that hydrophilic polymers, preferably selected from the polyacrylic acids and salts thereof constitute particularly useful detecting components for the detecting layer and lead to devices having very high color intensities and low response and secondary swell times. Moreover, firmly adhering films can be produced on most light-reflecting substrates. Polyacrylic acids as such and also their salts are familiar to one skilled in the art. They are polymers of the formula

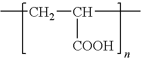

generated in the free-radical polymerization of acrylic acid for example. Polyacrylic acids further include those synthesized by crosslinking copolymerization of acrylic acids with bi- or polyfunctional monomers or by partial crosslinking with multivalent ions. The present inventors found that, unexpectedly, the use of polyacrylic acids or of salts thereof makes it possible to produce detecting layers reversibly responding particularly quickly to changes in the concentration of the chemical components to be detected, and also particularly intensive colorations or color changes in light reflected by the reflecting base layer.

In general, the device of the present invention initially comprises a light-reflecting substrate or background. The light-reflecting substrate or the background serves as a reflecting background and therefore should permit at least a partial, in particular an ideally complete, reflection of the light wavelength or lengths used for detection. In principle, any material that appears suitable to one skilled in the art can be used. In one preferred embodiment, the light-reflecting substrate or light-reflecting background comprises a metal, in particular Al, Au, Ag, Cr or Si, for which even the use in the form of a foil of metal or of a metallized or metal-coated film or layer is advantageously possible.

In a further preferred embodiment, the light-reflecting substrate or the background consists of a composite material or a self-supporting film having two or more layers, in particular of a polymeric film having a metallized layer, silverized glass or paper having a layer of metal. Not only flexible but also rigid substrates are possible. Depending on the desired use or embodiment, the light-reflecting substrate or background can be permeable or impermeable to the chemical component to be detected. A substrate or background permeable to the chemical component to be detected can be sensible for example when the environment to be monitored is on that side of the light-reflecting substrate which is opposite to the detecting layer. In such a case, a layer impermeable to the chemical component to be detected could be applied for example to that side of the reflecting layer which is opposite the light-reflecting substrate.

A detecting layer comprising the at least one detecting component as described above, for example polyacrylic acid or one of its salts, is applied above the light-reflecting substrate or background. Polyacrylic acid (salt) here offers the further advantage that it is very simple to produce as a solution in various concentrations and to apply to a variety of materials with good adhesion. In a preferred embodiment, a solution (in particular an aqueous solution) of a polyacrylic acid or one of its salts is initially prepared and then applied to the reflecting background or the light-reflecting substrate.

It has been determined to be particularly beneficial for the thickness of the detecting layer to be below 10 μm, in particular below 2 μm and more preferably below 0.2 μm. The thickness of the detecting layer is preferably in the range from 1 nm to 10 μm, in particular in the range from 1 nm to 2 μm, more preferably in the range from 10 nm to 1 μm, even more preferably in the range from 50 nm to 700 nm, more preferably between 50 nm and 500 nm. Layer thicknesses between 100 and 600 nm and in particular between 200 and 500 nm are also preferred. This ensures a rapid and even takeup in the detecting layer of the substance, in particular water vapor, to be detected.

Takeup of the chemical component to be detected causes a change in its layer thickness. This change in layer thickness can again be perceived or measured against the light-reflecting substrate or background as a color change in the reflected light.

It was found that, surprisingly, a particularly intensive color change coupled with high reversibility and a short response time on the part of the detecting layer can be actualized by using an alkali metal salt of polyacrylic acid. Thus, in a particularly preferred embodiment of the present invention, a lithium, sodium, potassium and/or ammonium salt of at least one polyacrylic acid is used for the detecting layer. The best results are obtained with lithium salts of polyacrylic acid, so that these are particularly preferred.

In a further preferred embodiment of the present invention, the molecular weight of the polyacrylic acid used or of its salt is between about 5000 and 500 000, in particular about 25 000 to 250 000 and more preferably 50 000 and 100 000. It was further found that, surprisingly, the reproducibility of the color change of the detecting layer as a function of the humidity in the environment to be monitored can be further enhanced when the polyacrylic acid in the detecting layer is present in partially or completely neutralized form, the use of alkali metal hydroxides and alkali metal carbonates being preferable. Preferably, the pH of the polyacrylic acid or salt solution used for forming the detecting layer is between about 2 and 7, in particular between about 3 and 7 and more preferably between about 5 and 7. The pH can be determined for example at 23° C. in a 10% by weight aqueous solution using a pH meter (inoLab, pH Level 1; from WTW Wissenschaftlich-Technische Werkstätten GmbH, Weilheim; the instrument is calibrated with buffer solutions in accordance with manufacturer instructions). Preferably, the degree of neutralization of the polyacrylic acids used is accordingly about 5% to 70%, more preferably about 10% to 60% and particularly about 15% to 50%. Neutralization is preferably effected using an alkali metal hydroxide or an alkali metal carbonate.

As well as the particularly preferred detection of humidity, i.e., water or water vapor in the air, the device of the present invention can in a further embodiment also be used for detecting further chemical components. One example thereof is the detection of other volatile solvents, examples being acetone or ethanol, although these examples are not to be viewed as restrictive. The respective color change obtained by means of the present invention's device as a function of the concentration of the chemical component to be detected in the environment to be monitored can in each case be determined by one skilled in the art in a few routine tests. The device of the present invention can thus simply be placed in defined environments comprising respectively different (known) concentrations of the chemical component to be detected and the respective color or color change determined. Preferably, the chemical components to be detected comprise gaseous components and the environment to be monitored preferably comprises a gaseous medium, for example air. One example here is the monitoring of the relative humidity in the air in a container for a moisture-sensitive product.

In a further preferred embodiment of the present invention, the salt of the polyacrylic acid contains organic cations. Preferred organic cations are ammonium, sulphonium and phosphonium ions. Preference here is given to quaternary ammonium ions of the formula

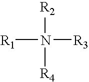

where R₁, R₂, R₃ and R₄ are independently hydrogen, an aliphatic radical having one to 18 carbon atoms (C1 to C18), an aromatic radical preferably of six carbon atoms, an aliphatic (C1 to C18)/aromatic (C6) radical or a heterocyclic radical containing N, O, S or P. Crosslinked polyacrylic acids can also be used.

It is further preferred, as observed above, in the present invention that the at least one detecting component is homogeneously distributed in the detecting layer on the light-reflecting background or substrate. It is particularly preferable for the detecting layer to be present as a homogeneous monolayer. This makes it possible to actualize a particularly simple as well as efficient construction. However, two or more detecting layers are also possible instead of just one detecting layer.

It is also possible in the realm of the present invention for the device, as well as the at least one detecting layer, to contain further layers, in particular layers serving as color filters or polarizing filters. Similarly, the use of covering layers, in particular to prevent damage or mechanical abrasion of the detecting layer, is possible. Accordingly, such covering layers are applied on the outside with regard to the detecting layer to permit efficient protection when the detecting device of the present invention is in use. Examples of suitable materials are polyamide (PA), polyacrylonitrile (PAN) and also polyethylene terephthalate (PET).

In a preferred embodiment of the present invention, the device as well as the reflecting substrate or background and the detecting layer also comprises a layer, in particular a partially reflecting (semireflecting) layer, composed of at least one metal such as for example gold, aluminum, chromium, nickel, silver or silicon or a metal oxide such as chromium oxide or titanium oxide. Such a layer is advantageously applied on that side of the detecting layer which is opposite the reflecting substrate or background, for example as an outer covering layer on the detecting layer. The layer should preferably be permeable to the chemical component to be detected. It should further be at least partially transmissive (semireflecting, i.e., neither completely transmissive nor fully reflecting) at least to the light used for detection. Preferably, the layer comprises a layer applied by metal vapor deposition or as a sputtered coating.

It will be understood that the layers above the light-reflecting substrate or background should ideally be at least partially transparent to the light wavelength used for detecting the color change. Preferably, the light wavelengths are in the visible region. However, in principle, when suitable detecting devices are used, wavelengths in the infrared or ultraviolet region can also be used. The device of the present invention thus preferably comprises an optical indicator or detecting element.

It will also be understood that any layer between the detecting layer and the environment to be monitored also has to have an appropriate permeability to the chemical component to be detected. In the case of the chemical component to be detected comprising water or water vapor, a moisture vapor transmission rate of at least about 1 g per m² per day, preferably more than about 10 g per m² per day, in particular more than 100 g per m² per day (ISO 15106-3), is sensible and preferred.

The detecting layer can in principle be applied to the reflecting background or the light-reflecting substrate using any method familiar to one skilled in the art, including spin coating, dip coating, spray coating, kiss coating, screen printing and the like. It has been found to be particularly preferable and beneficial with regard to producing an even layer thickness for the detecting layer for the application to be effected by means of spin coating, screen printing or dip coating. These methods are known per se to one skilled in the art, and conventional devices can be used.

The viscosity of the detecting component used can be influenced for example by changing the concentration or the solvent or suspendant. When polyacrylic acid is used, for example, the viscosity of the polyacrylic acid (salt) solution used to apply the detecting layer can also be influenced via the molecular weight thereof. It is preferable to use water as solvent. However, other solvents such as ethanol or aqueous ethanolic solutions are also possible. It is further preferable for the concentration of the polyacrylic acid or its salt in the application solution used to be between about 0.5% and 30% by weight, in particular between about 1% and 20% by weight and more preferably between about 2% and 10% by weight. The viscosity is preferably in the range from 1 to 1500 m·Pas. Viscosity was measured to DIN 53015.

The surface tension is preferably in the range from 30 to 90 and preferably 45 to 85 mN/m. Surface tension was determined to DIN 53914.

In a further embodiment of the present invention, the surface tension or viscosity can also be influenced through the addition of wetting agents or the like. A nonrestrictive example of a suitable wetting agent is N,N-dimethyl-N-hexadecyl-N-(3-sulfopropyl)ammoniumbetaine (for example from Raschig, trade name RALUFON DP). This wetting agent can be used for example in an amount of 0.01% to 1% by weight and in particular of about 0.1% by weight.

As mentioned above, one unexpected advantage of using polyacrylic acid or salts thereof in the detecting layer, as well as the rapid, reversible and intensive color generation or shifting, is the possibility of producing a firmly adhering even detecting layer in a simple manner. If, in individual cases, the adhesion of the detecting layer is nonetheless insufficient, a conventional treatment (roughening, compatibilization) of the surface of the light-reflecting substrate or background is a possible option for improving the adhesion of the superior detecting layer. These methods are known per se to one skilled in the art.

In a particularly preferred embodiment of the present invention, the device described above is an optically readable indicator element, in particular a so-called indicator card. Such an indicator card is a simple way to determine the presence or concentration in an environment to be monitored of the chemical component to be detected. Indicator cards as such are familiar to one skilled in the art and need not be described here any further. Examples of the construction of suitable indicator elements from a plurality of layers are known for example from U.S. Pat. No. 5,224,373, U.S. Pat. No. 4,034,609 and EP 1 305 621. Their disclosure with regard to the construction of an indicator element from a plurality of layers or parts is in this respect hereby expressly incorporated herein by reference.

A further aspect of the present invention concerns packaging of any kind, for example for a pharmaceutical product, comprising a device or indicator element as described above. The device or indicator element may preferably form an integral constituent of the packaging. Preferably, the device or indicator element is positioned such that it is readily accessible or visible for being read off. In a further aspect of the present invention, the device of the present invention can also be used (alone or additionally) for decorative purposes or as a decorative element on/in products such as consumer goods.

One example of a particular embodiment according to the present invention is a blister pack for a pharmaceutical product, consisting in a conventional manner of a see-through plastics film and a sealable aluminum foil bonded thereto. The sealable aluminum foil, then, can serve as reflecting substrate atop of which the detecting layer of the present invention is applied. This makes it possible to determine through the see-through plastics film, from the color or color shift of the detecting layer in the light reflected by the sealable aluminum foil, to what extent the relative humidity in the interior of the blister pack is still within the acceptable range and accordingly that the blister pack is free of any damage through which moisture in the air was able to enter.

A further aspect of the present invention provides a desiccant-containing product in which the above-described device of the present invention, or the indicator element, is used for checking the moisture content in the desiccant-containing product. An example here is a container for a pharmaceutical product (tablets for example), which also accommodates a desiccant bag or canister. By applying the present invention's device or the indicator element in the container interior, it is then possible to check for example by looking at the sealed container (for example through a sight window or a transparent region) to what extent the acceptable relative humidity has not been exceeded therein and that the desiccant used is still sufficiently active.

A further aspect of the present invention finally concerns a process for detecting at least one chemical component, which comprises the chemical component to be detected being contacted with at least one detecting layer as herein described, for example containing a polyacrylic acid or one of its salts, and the detecting layer changing its layer thickness in interaction with the component to be detected, so that the color of the detecting layer in reflected light changes, in particular compared with a reflecting surface lying behind the detecting layer. A device as described above or to be more precise a detecting layer containing for example the present invention's polyacrylic acid or one of its salts may preferably be used for qualitative or quantitative determination of the chemical compound, in particular the moisture in the air, to be detected. When the color or color change produced is in the region visible to the human eye, which is preferable, optical measuring elements are not absolutely required. However, it can be beneficial in many cases to use known optical measuring elements which permit an accurate determination of the wavelength of the reflected light over a wide range in order that the color or color change of the reflected light may be accurately captured both qualitatively and quantitatively. One preferred embodiment utilizes for this purpose an automated measuring and reading system as also used in other photospectrometric measurements.

A particularly preferred embodiment of the present invention utilizes the present invention's device described herein and the present invention's process described herein to determine the humidity or humidity changes at any desired relative humidity, preferably between about 5% and 90%, more preferably at a relative humidity of less than 30%, preferably less than 15%, particularly less than 10% and more preferably less than 5%, in the environment to be monitored. It has surprisingly emerged that both rapid and reproducible measurement is possible even at these comparatively low moisture contents and intensive colors or color changes can be produced by means of the detecting layer of the present invention even in this range. Quantitative determination by means of the present invention's devices of the chemical component to be detected is possible by initially putting these devices in environments of known concentrations of the chemical component to be detected and reading off the coloration. This calibration can then be used to assign unknown concentrations of the chemical component to be detected to the appropriate coloration.

The invention will now be more particularly elucidated by the nonrestrictive examples which follow:

### EXAMPLE 1

1 g of an NaOH-neutralized 33% by weight polyacrylic acid solution (from Stockhausen, designation AMV A11505 (Na⁺), M_{w}=50 000) is applied to a silicon wafer (from Silchem, one-sidedly polished, diameter 50.8 mm, orientation <100>±1°, type p/boron, specific resistance 1-2 ohmcm, thickness 275±25 μm, without secondary phase) by spin coating at 60 rps. Before spin coating, the solution is adjusted to pH 5 (HCl) and filtered with a membrane filter (CHROMAFIL®). The molar ratio of alkali metal anions to polyacrylic acid in the solution used was between 300 and 6500. The sample is dried for three minutes and thereafter shows a certain color (blue). After drying in a drying cabinet or treatment in a conditioning cabinet, the sample has a different color, depending on the particular relative humidity.

### EXAMPLE 2

1 g of an LiOH-neutralized 33% by weight polyacrylic acid solution (from Stockhausen, designation AMV A11438 (NH₄⁺), M_{w}=50 000) is applied to a silicon wafer (from Silchem, one-sidedly polished, diameter 50.8 mm, orientation <100>±1°, type p/boron, specific resistance 1-2 ohmcm, thickness 275±25 μm, without secondary phase) by spin coating at 70 rps. Before spin coating, the solution is adjusted to pH 7 and filtered with a membrane filter (CHROMAFIL®). The molar ratio of alkali metal ions to polyacrylic acid in the solution used was between 300 and 6500. The sample is dried for three minutes and thereafter shows a certain color (blue). After drying in a drying cabinet or treatment in a conditioning cabinet, the sample has a different color, depending on the particular relative humidity.

### EXAMPLE 3

1 g of an LiOH-neutralized 2.56 by weight polyacrylic acid solution (from Sigma-Aldrich, M_{w}=450 000) is applied to a silicon wafer (from Silchem, one-sidedly polished, diameter 50.8 mm, orientation <100>+1°, type p/boron, specific resistance 1-2 ohmcm, thickness 275±25 μm, without secondary phase) by spin coating at 70 rps. Before spin coating, the solution is adjusted to pH 5 and filtered with a membrane filter (CHROMAFIL®). The molar ratio of alkali metal ions to polyacrylic acid in the solution used was between 300 and 6500. The sample is dried for three minutes and thereafter shows a certain color (blue). After drying in a drying cabinet or treatment in a conditioning cabinet, the sample has a different color, depending on the particular relative humidity.

### EXAMPLE 4

0.4 g of waterglass (Na₂O 8.15% and SiO₂ 27.06%) is applied to a silicon wafer (from Silchem, one-sidedly polished, diameter 50.8 mm, orientation [100]+/−1°, type P/boron, specific resistance 1-2 ohmcm, thickness 275+/−25 μm, no secondary phase) by spin coating at 70 rps. The sample is dried for 3 minutes and thereafter shows a blue color. After drying in a drying cabinet or treatment in a conditioning cabinet, the sample has a different color, which depends on the particular relative humidity.

### EXAMPLE 5

0.4 g of a 7.5% by weight polyvinylcaprolactam solution (solvent: ethanol) (from BASF, Luviskol Plus, 40% solution in ethanol) is applied to a silicon wafer (from Silchem, as indicated in the preceding example) by spin coating at 70 rps. Before spin coating, the solution is filtered with a membrane filter (CHROMAFIL®). The sample is dried for 3 minutes and thereafter shows a blue color. After drying in a drying cabinet or treatment in a conditioning cabinet, the sample has a different color, which depends on the particular relative humidity.

### COMPARATIVE EXAMPLE 6

For comparison, a multilayered film comprising alternating plies of synthetic hectorite and the polyelectrolyte poly(diallyl-dimethylammonium chloride) (PDDA) was produced in accordance with the paper by Kleinfeld and Ferguson (loc. cit.) on corresponding silicon wafers and with an appropriate layer thickness as in example 1.

The samples produced in accordance with examples 1 to 6 were then transferred into a conditioning cabinet at 25° C. and 40% relative humidity. The color intensity of the resulting coloration of the layer in reflected light was visually compared. The results are summarized in table 1.

By rapidly changing the relative humidity (in each case at 25° C.) between 40% and 10%, the response time of the devices according to examples 1 to 6 in changing color was visually compared (response behavior). The results are summarized in table 1.

Finally, the evenness of the coloration of the devices according to examples 1 to 6 were compared in a conditioning cabinet at 25° C. and 40% relative humidity. The results of the visual inspection are again to be found in table 1.

Finally, the secondary swell behavior of the devices according to examples 1 to 6 was determined, from the secondary change in the coloration after a change from 40% relative humidity (25° C.) to 10% relative humidity (25° C.). The time delay was observed until the color of the sample in reflected light stopped changing. This criterion can serve as an indication as to how rapidly an equilibrium with regard to the takeup of water vapor from the environment has become established, so that the layer stops swelling and stable color output is possible. These results are also summarized in table 1.

TABLE 1

| | Color | Response | Evenness of | Secondary |
|---|---|---|---|---|
| Example | intensity | behavior | coloration | swell behavior |
| No. | (*) | (**) | (***) | (****) |
| 1 | +++ | +++ | +++ | ++ |
| 2 | +++ | +++ | +++ | +++ |
| 3 | +++ | +++ | +++ | +++ |
| 4 | +++ | +++ | +++ | ++ |
| 5 | ++ | ++ | +++ | +++ |
| 6 | + | ++ | + | + |

(*) to (****) the individual criteria where visually assessed by five people working independently. The results were averaged and rounded.
(*) + = weak to moderate; ++ = good; +++ = very good
(**) + = distinct delay in color change; ++ = small delay in color change; +++ = virtually no visible delay in color change
(***) + = strongly uneven coloration; ++ = somewhat uneven coloration; +++ = uniform coloration
(****) + = distinct secondary change to coloration; ++ = slight secondary change to coloration; +++ = virtually no visible secondary change to coloration

### EXAMPLE 7

A polyacrylic acid solution (Sigma-Aldrich, Mw=100 000) is partially neutralized by means of 1 molar KOH solution up to a certain pH (3, 4, 5, 6, 7, 8 or 9). The molar ratio of alkali metal ions to polyacrylic acid in the solution used was between and 6500 for the pH 3 to 7 range. This polymer solution is then spin coated onto a silicon wafer at 70 rps. The samples were dried and the intensity of the color obtained was visually assessed.

| | Color intensity |
|---|---|
| pH | (0-5, 0- poor to 5- very good) |
| 3 | 2 |
| 4 | 3 |
| 5 | 5 |
| 6 | 5 |
| 7 | 5 |
| 8 | 0 |
| 9 | 0 |

1. A device for detecting at least one chemical component, the device comprising a light-reflecting substrate or light-reflecting background and a detecting layer arranged on the substrate or background, wherein the detecting layer comprises at least one component swellable in the presence of the component to be detected, the detecting layer consisting of a homogeneous material and the component to be detected comprising water.

2. The device of claim 1 wherein the component swellable in the presence of the chemical component to be detected comprises at least one salt of a polyacid or of a polymeric acid.

3. The device of claim 2 wherein the polyacid or polymeric acid comprises at least one polyacrylic acid.

4. The device of claim 2 wherein the salt comprises an alkali metal salt.

5. The device of claim 4 wherein the molar ratio of alkali metal salt ions to polyacid is between 50 and 6500.

6. The device of claim 1 wherein the component swellable in the presence of the chemical component to be detected consists essentially of at least one salt of a polyacrylic acid.

7. The device of claim 3 wherein the at least one salt of a polyacrylic acid comprises a completely or partially neutralized polyacrylic acid partially or completely neutralized, with alkali metal hydroxides or alkali metal carbonates.

8. The device of claim 3 wherein the polyacrylic acid or its salt has a pH between about 3 and 7.

9. The device of claim 1 wherein the detecting layer does not contain a platelet-shaped sheet-silicate.

10. The device of claim 1 wherein the component swellable in the presence of the chemical component to be detected comprises a hydrophilic polymer.

11. The device of claim 1, characterized in that the detecting layer has a takeup capacity for water of 10% to 30% by weight.

12. The device of claim 1 wherein the light-reflecting substrate or the light-reflecting background comprises a metal.

13. The device of claim 1, characterized in that the light-reflecting substrate comprises a composite material or a self-supporting film having two or more layers.

14. The device of claim 3, characterized in that the salt of the polyacrylic acid contains organic cations.

15. The device of claim 1, characterized in that swelling of the detecting layer is reversible.

16. The device of claim 1, characterized in that the reflecting substrate comprises a silicon wafer.

17. The device of claim 1, characterized in that the reflecting substrate comprises a flexible or rigid surface.

18. The device of claim 3, characterized in that the polyacrylic acid or its salt has a molecular weight between about 5000 and 500 000.

19. The device of claim 1 further comprising further components which change their layer thickness in response to an interaction with a chemical component.

20. The device of claim 1 further comprising further layers selected from the group consisting of one or more color filters, polarizing layers and covering layers which prevent damage or mechanical abrasion.

21. The device of claim 1 further comprising a partially reflecting layer on that side of the detecting layer which is opposite to the reflecting substrate or background.

22. The device of claim 21, characterized in that the partially reflecting layer comprises a metal layer applied by metal vapor deposition or sputtering.

23. The device of claim 1, characterized in that all layers above the light-reflecting substrate are completely or partially transparent.

24. The device of claim 1, characterized in that the chemical component to be detected comprises water vapor.

25. The device of claim 1, characterized in that the viscosity of the detecting layer at the time of its application is in the range between 1 to 1500 m·Pas.

26. The device of claim 1, characterized in that the surface tension of the detecting layer at the time of its application is between 30 and 90 mN/m.

27. The device of claim 1, characterized in that the detecting layer further comprises at least one wetting agent to set the surface tension.

28. The device of claim 1, characterized in that the detecting layer is applied utilizing a method selected from spin coating, dip coating, screen printing, spray coating and kiss coating.

29. The device of claim 1, characterized in that a surface of the light-reflecting substrate is surface treated to improve adhesion of a superior layer or layers.

30. The device of claim 1, characterized in that upon contact of the detecting layer with water, a color change occurs in the visible wavelength region of light reflected off the light-reflecting substrate or light reflecting background.

31. The device of claim 1, characterized in that the device comprises an optically readable indicator element.

32. The device of claim 30, characterized in that the color change is read out using an optical measuring element.

33. Packaging for a pharmaceutical product, comprising the device according to claim 1.

34. The packaging of claim 33, characterized in that the device is arranged on the packaging so as to be visible.

35. The packaging of claim 33, characterized in that the packaging comprises a blister pack having a see-through plastics film and a sealable aluminum foil and the sealable aluminum foil of the blister pack serves as reflecting substrate.

36. A desiccant-containing product, comprising the device of claim 1 which indicates the moisture content in the desiccant-containing product.

37. A process for detecting at least one chemical component, which comprises contacting at least one detecting layer with the chemical component and changing a layer thickness of the detecting layer through interaction with the component to be detected so that color of the detecting layer in reflected light changes wherein the component to be detected comprises water or water vapor and the detecting layer consists of a homogeneous material.

38. The process of claim 37, characterized in that the detecting layer does not contain platelet-shaped sheet-silicate.

39. (canceled)

40. (canceled)

41. (canceled)

42. (canceled)
